(19) United States
(12) Patent Application Publication
(10) Pub. No.: US 2011/0213120 A1
(43) Pub. Date: Sep. 1, 2011

(54) ROSIN ESTERS FOR NON-WOVEN APPLICATIONS, METHODS OF MAKING AND USING AND PRODUCTS THEREFROM

(75) Inventors: Gary W. Astrologes, Savannah, GA (US); George A. Locko, Savannah, GA (US); Abhay Deshpande, Savannah, GA (US); Steven C. Gailbreath, Fruit Cove, FL (US)

(73) Assignee: ARIZONA CHEMICAL COMPANY

(21) Appl. No.: 12/714,625

(22) Filed: Mar. 1, 2010

(51) Int. Cl. C09F 1/04

(52) U.S. Cl. 530/218

(57) ABSTRACT

Rosin esters having suitable color, color stability and/or odor to make them useful for non-woven applications, to non-woven products made from and/or comprising rosin esters, and to methods of making and using such rosin esters and products.

### RELATED APPLICATION DATA

Not applicable.

### BACKGROUND OF THE INVENTION

1. Field of the Invention

The present invention relates to rosin esters, to products made from or comprising rosin esters, and to methods of making and using such rosin esters or products. In another aspect, the present invention relates to rosin esters useful for non-woven applications, to non-woven products made from and/or comprising rosin esters, and to methods of making and using such rosin esters and products. In even another aspect, the present invention relates to rosin esters having suitable color, color stability and/or odor to make them useful for non-woven applications, to non-woven products made from and/or comprising rosin esters, and to methods of making and using such rosin esters and products.

2. Brief Description of the Related Art

Currently, rosin esters are not acceptable for the non-woven adhesives industry. As a non-limiting example, for employment as adhesives used in construction of disposable baby diapers. Mostly, hydrogenated hydrocarbon resin based tackifiers are most commonly accepted for utilization in non-woven applications. While there are a number of reasons for why rosin esters are not acceptable for use in the non-woven adhesives applications, the main ones are presently that previous and current tall oil rosin based rosin esters neither have the color, color stability nor the low odor for use in non-woven adhesives.

Head-space GC-MS studies at the Princeton laboratories demonstrated that a significant number of powerful malodor components were present in rosin esters. Some of these malodorous chemical species, which were present at low to almost non-detectable levels were low molecular weight aldehydes and carboxylic acids. Additional work done at Princeton soon after the headspace studies had shown that both a rosin ester made from CHDM (cyclohexane dlmethanol), and the corresponding hot melt adhesive had substantially improved odor. However, the problem was that the CHDM-based rosin ester had too low a Softening Point (SP) to be used effectively in most hot melt adhesives. See, Princeton Technology Center Mass Spectrometry Laboratory Reports issued February 1998 and Apr. 5, 1996.

U.S. Pat. No. 4,302,371, issued on Nov. 24, 1981, to Matsuo, et al., discloses a stabilized rosin ester and pressure-sensitive adhesive and hot-melt composition based thereon. The process for preparing a stabilized rosin ester having a higher softening point comprises subjecting a rosin to disproportionation and purification, and esterifying the resulting purified disproportionated rosin with a tri- or more valent polyhydric alcohol to give a rosin ester having a softening point (according to ring and ball method) of 65.degree. to 140.degree. C. The resulting rosin ester has superior heat resistance and aging resistance as well as a high softening point and is suitably employed as a tackifier for pressure-sensitive adhesive compositions and hot-melt compositions.

U.S. Pat. No. 4,585,584, issued Apr. 29, 1986, to Johnson, Jr., et al., discloses a process for preparing rosin esters of improved color. Tall oil rosin esters of pentaerythritol prepared in the presence of activated carbon possess an improved, lighter color.

U.S. Pat. No. 4,643,848, issued Feb. 17, 1987, to Thomas, et al., discloses a modified rosin ester preparation. Phosphinic acid (also called hypophosphorous acid), when used in very small quantities, is disclosed to act as a catalyst to accelerate the reaction of rosin with an unsaturated dibasic acid to form a modified rosin for subsequent esterification with a polyhydric alcohol. According to the process of the invention, a rosin is reacted with an unsaturated dibasic acid such as maleic anhydride or fumaric acid in the presence of phosphinic acid at a temperature of from about 180.degree. C. to about 220.degree. C. When the modified rosin is subsequently esterified, the rosin ester exhibits improved color, softening point, and viscosity in a specified solution.

U.S. Pat. No. 4,657,703, issued Apr. 14, 1987, to Durkee, discloses a method of improving the color of tall oil rosin esters. The method of improving the color of tall oil rosin esters comprises the sequential steps of (a) heating and stirring a tall oil rosin in the presence of a Lewis acid catalyst to form a mixture, (b) distilling the mixture to provide a tall oil rosin distillate, and (c) esterifying the tall oil rosin distillate with a polyol in the presence of a phenol sulfide compound. The improved tall oil rosin esters produced thereby are useful in the manufacture of a variety of products, such as paper and textile sizes, plasticizers for polyolefin films, paints, varnishes, hot melt adhesives and pressure sensitive adhesives.

U.S. Pat. No. 5,162,496, issued Nov. 10, 1992 to Johnson, Jr., discloses a method for the preparation of light-colored rosin esters. The catalytic combination of a phosphite ester and a phenol sulfide accelerates and mediates the esterification reaction of rosin with a polyhydric alcohol, resulting in esterified rosins having numerous advantageous characteristics and particular utility as tackifiers in hot melt adhesives.

U.S. Pat. No. 5,504,152, issued Apr. 2, 1996, to Schluenz, et al., discloses esterification of rosin. The method for esterifying rosins with a polyol which comprises contacting rosin with the polyol in the presence of a bleaching mixture which includes both an alkaline earth hypophosphite and hypophosphorous acid and, preferably also, an organic sulfide, under esterification conditions to produce a rosin ester. The method enables production of rosin esters which have a color of less than about 5 Gardner neat. The preferred bleaching mixture includes from about 0.01% to about 0.10% of the alkaline earth hypophosphite and from about 0.10% to about 0.15% of active hypophosphorous acid, where the amounts are based on the weight of the rosin. The most preferred alkaline earth hypophosphite is calcium hypophosphite. The specification also describes a method for preparing an adhesive from the rosin ester.

U.S. Pat. No. 5,830,992, issued Nov. 3, 1998, to Whalen, discloses a light color, color stable rosin esters and methods for preparing same. Rosin esters that are both light colored and color stable are produced by reacting polyhydric alcohol with an equivalent excess of rosin, in the presence of calcium bis(monoethyl(3,5-di-tert-butyl-4-hydroxybenzyl)phosphonate. When phosphinic acid is added to the reaction mixture, light colored and color stable rosin esters are produced regardless of whether the rosin or polyol are in equivalent excess, although preferably the rosin is in equivalent excess. It is preferred to include a phenol sulfide compound, such as Vultac® 2, with the calcium bis(monoethyl(3,5-di-tert-butyl-4-hydroxybenzyl)phosphonate, and to add the phosphinic acid incrementally after the acid number of the rosin and polyhydric alcohol reaction mixture has dropped to about 100. Excess rosin is preferably stripped from the product mixture at about 275.degree. C.

U.S. Pat. No. 5,969,092, issued Oct. 19, 1999, to Karvo, discloses preparation of a tall oil rosin ester with a low odor level. This process for the preparation of a tall oil rosin ester with a low odor level, comprises an esterification step wherein a tall oil rosin is esterified with a polyol in order to form a product which contains a tall oil rosin ester, and evaporation is carried out on this product in order to remove odor components and other volatile components from the product, which evaporation is carried out in a short-path evaporator which has an evaporation surface and, in the vicinity of this surface, a condenser on which the vaporized components to be removed condense, whereupon a tall oil rosin ester with a low odor level is recovered from the evaporator.

U.S. Pat. No. 6,562,888, issued May 13, 2003, to Frihart, et al., discloses light-colored rosin esters and adhesive compositions. These rosin esters are both light-colored and color stable may be produced by reacting rosin with an organic compound containing two or more hydroxyl groups each separated from each other by at least four carbon atoms. With appropriate choices for the esterification catalyst and antioxidant(s), the rosin ester may be useful as a tackifier, and can be formulated into an adhesive composition. The adhesive compositions will further comprise an appropriate adhesive polymer.

WO 2007092250 published Aug. 16, 2007, and US Publication 20070179277 published Aug. 2, 2007, both to Anthony Dallavia, disclosed a rosin ester with low color and process for preparing same. The process for producing light color rosins ester resin, preferably based on tall rosin is conducted in the presence of less than 10 weight % of an acid functional organic compound and avoids the need for use of a stoichiometric excess of rosin acid, or a stoichiometric excess of polyol hydroxy groups. The process allows for the use of lower colored or darker tall oil rosin in the production of low color rosin esters.

All of the patents, applications and publications cited in this specification, are herein incorporated by reference.

However, in spite of the above advancements, there exists a need in the art for rosin esters, for products there from, and for methods of making and using such resin esters and products.

There is another need for alternative adhesives to the hydrogenated hydrocarbon resin based tackifiers that have been found acceptable in non-woven applications.

There is even another need in the art for rosin esters with suitable color, color stability and/or odor, for example for non-woven applications.

There is still another need in the art for tackifiers.

There is yet another need in the art for tackifiers for EVA packaging adhesives that give increased viscosity stability to the adhesive.

There is even still another need in the art for new tackifiers for pressure sensitive adhesives (PSA) with a low color at a lower cost than with the use of hydrogenated hydrocarbon resin based tackifiers.

There is even still a need in the art for new tackifiers for bookbinding adhesives that offer a low color and improved viscosity stability at a low cost.

These and other needs in the art will become apparent to those of skill in the art upon review of this specification, including its drawings and claims.

### SUMMARY OF THE INVENTION

Various embodiments of the present invention may fulfill none, one or more of the following objects.

It is an object of the present invention to provide for rosin esters, for products there from, and for methods of making and using such resin esters and products.

It is another object of the present invention to provide for alternative adhesives to the hydrogenated hydrocarbon resin based tackifiers that have been found acceptable in non-woven applications.

It is even another object of the present invention to provide for rosin esters with suitable color, color stability and/or odor.

It is still another object of the present invention to provide for tackifiers.

It is yet another object of the present invention to provide for tackifiers for EVA packaging adhesives that give increased viscosity stability to the adhesive.

It is even still another object of the present invention to provide for tackifiers for pressure sensitive adhesives (PSA) with a low color at a lower cost than with the use of hydrogenated hydrocarbon resin based tackifiers.

It is even yet another object of the present invention to provide for tackifiers for bookbinding adhesives that offer a low color and improved viscosity stability at a low cost.

These and other objects of the present invention will become apparent to those of skill in the art upon review of this specification, including its drawings and claims.

According to one embodiment of the present invention, there is provided method of producing a rosin ester. The method may include any one or more of the following steps in any order: contacting a rosin having PAN isomers with disproportionation agent to provide a rosin having a PAN number less than 45 providing a disproportionated rosin; contacting the disproportionated rosin with an adduction agent to further reduce the PAN number to provide an adducted rosin; and/or contacting the adducted rosin with a polyhydric polyol to form a rosin ester.

According to another embodiment of the present invention, there is also provided a method of producing a rosin ester. The method may include one or more of the following steps in any order: contacting rosin having a PAN number less than 45 with an adduction agent to further reduce the PAN number to provide an adducted rosin; contacting the adducted rosin with a polyhydric polyol to form a rosin ester.

According to even another embodiment of the present invention, there is provided a rosin ester composition having an odor intensity of less than 80% relative to comparison rosin ester made from 100% pentaerythritol.

According to still another embodiment of the present invention, there is provided an adhesive comprising a rosin ester composition having an odor intensity of less than 80% relative to comparison rosin ester made from 100% pentaerythritol.

According to yet another embodiment of the present invention, there is provided a non-woven product comprising an adhesive comprising a rosin ester composition having an odor intensity of less than 80% relative to comparison rosin ester made from 100% pentaerythritol.

### DETAILED DESCRIPTION OF THE INVENTION

In the practice of certain non-limiting embodiments of the present invention, a process has been developed to synthesize rosin esters with lower odor, lighter color, and/or improved color stability compared to prior art technology. Certain embodiments of the rosin ester compositions of the present invention have substantially improved color stability at temperatures up to 150 C and/or these compositions impart excellent thermal stability to a hot melt adhesive upon aging at temperatures up to 150 C. These certain resulting rosin esters are suitable for use in conventional packaging and pressure sensitive adhesives, and unlike conventional rosin esters it can also be used for odor and color sensitive applications such as non-woven adhesives (diaper construction adhesives) or other high-end packaging adhesives.

In the practice of the present invention, possible approaches for providing a low odor RE adhesive included using a polyol other than pentaerythritol (PE), using a mixture of polyols, or to significantly reduce the PE content in rosin ester formulations by replacement of part or all of the PE with one or more other types of polyols.

Specifically one non-limiting embodiment of the present invention provides fumaric-modified esters based upon a polyol component that may be a blend of polyols, a non-limiting example of which includes glycerol and PE. Some of the embodiments may provide lighter color and lower odor as compared to commercial Sylvalite® Rosin Ester and may also provide superior color stability and viscosity stability upon aging or storage at elevated temperatures simulating warehouse conditions.

Some of the embodiments of the present invention will provide an adhesive with the lower initial color and lower aged color as compared to commercial adhesives. Some of the embodiments of the present invention provide smaller viscosity change on aging as compared to commercial adhesives. As a non-limiting example, the viscosity change of adhesives made from some embodiments of the rosin esters of the present invention may be less than 5%, 4%, 3%, 2% or 1%, after aging for 96 hours at 350 F.

Some embodiments of the present invention may utilize a partial disproportion step. It was also noticed that the rosin color may decreases during this step, although the final ester may not necessarily be unusually light in color.

It should be appreciated, methods and agents for rosin disproportionation are well known, and that any suitable disproportionation method(s) and agent(s) may be utilized, and the present invention is not to be limited to any particular method or agent. Certainly one or more disproportionation methods and agents may be utilized. Non-limiting examples of suitable disproportionation methods and agents are provided in U.S. Pat. No. 3,423,389, U.S. Pat. No. 4,302,371 and U.S. Pat. No. 4,657,703 all herein incorporated by reference.

Disproportionation agents may fall into several classes. Some embodiments of the present invention utilize phenol sulfide type of agents. As specific non-limiting examples, Rosinox™ (poly-t-butylphenoldisulfide available from Arkema, Inc.), Lowinox™ TBM-6 (4,4′-thiobis(2-t-butyl-5-methylphenol available from Chemtura), Ethanox™ 323 (nonylphenol disulfide oligomer available from Albemarle Corp.), and/or Vultac™ 2 (amylphenol disulfide polymer available from Sovereign Chemical Co.).

Other non-limiting examples of suitable disproportionation agents include thiobisnaphthols in general. Suitable non-limiting examples include but are not limited to 2,2′-thiobis phenols, 3,3′-thiobisphenols, 4,4′-thiobis(resorcinol) and t,t′-thiobis(pyrogallol), 4,4′-thiobis(6-t-butyl-m-cresol) and 4/4′-thiobis(6-t-butyl-o-cresol) thiobisnaphthols, 2,2′-thio-bis phenols, 3,3′-thio-bis phenols, and the like.

Other non-limiting examples of suitable disproportionation agents include metals (non-limiting examples of which include but are not limited to palladium, nickel, platinum) or iodine or iodides (a non limiting example of which includes but is not limited to iron iodide) or sulfides (a non limiting example of which includes but is not limited to like iron sulfide).

In some embodiments, the rosin prior to disproportionation may have a PAN number on the order of about 50. As used herein, the PAN number is the sum of the percentage of rosin acids in the rosin that are Palustric Acid, Abietic Acid, and Neoabietic Acid. In some embodiments of the present invention disproportionation will result in a final PAN number from about 20-25. In other embodiments of the present invention disproportionation will result in a final PAN number from 15-30. In even other embodiments of the present invention disproportionation will result in a final PAN number from 10-40. Disproportionation may result in a final PAN number that is 0.1, 1, 2, 5, 10, 15, 20, 25, 35, 35, 40, or 45, or in any range from/to or between any two of the foregoing numbers.

Some embodiments of the present invention exhibit color improvement in disproportionated rosin and improved oxidation resistance of esters made from such rosin combined with the discovery that a fumaric acid adducted glycerol/pentaerythritol ester may exhibit improved odor and color stability. Certain embodiments of the present invention may provide a suitable low odor light color rosin ester that may be suitable for use in non-woven adhesives by implementing a proper combination of process and synthetic conditions.

As is well known in the prior art, rosin esters may be prepared from rosin, catalyst(s), bleaching agent(s), polyhydric alcohol(s) also as known as a polyols, and a stabilizer and/or antioxidant. Such catalyst, stabilizers and/or bleaching agents are known is the art as described, for example, in U.S. Pat. Nos. 2,729,660, 3,310,575, 3,423,389, 3,780,013, 4,172,070, 4,548,746, 4,690,783, 4,693,847, 4,725,384, 4,744,925, 4,788,009, 5,021,548 and 5,049,652.

In general, the process for making the rosin esters of the present invention may include contacting a rosin, preferably a molten rosin, with a polyhydric alcohol.

Suitable examples of rosins useful in the process of the invention may include but are not limited to gum rosin, wood rosin or tall oil rosin or any subsets or mixtures thereof. The preferred rosin is tall oil rosin. In some embodiments, the tall oil rosin may be an isomeric mixture primarily composed of C₂₀ fused-ring, monocarboxylic acid hydrocarbons and may be typified by levopimaric acid, abietic acid, pimaric acid and dehydroabietic acid. In the present invention, the amount of rosin used will vary depending on the end use application.

The gum, wood, tall oil and other rosins may be employed in the processes of the present invention as is, or alternatively may be subjected to other treatments prior to use in the present esterification process. For example, the rosin material may be subjected to distillation, disproportionation, hydrogenation or polymerization, or some combination of these and/or other treatments, prior to use in the subject processes.

Polyhydric alcohols, also sometimes referred to as polyols, the other reactant employed in the subject process, are also well known. Exemplary of such compounds are ethylene glycol, propylene glycol, diethylene glycol, triethylene glycol, tetraethylene glycol, trimethylene glycol, glycerol, pentaerythritol, dipentaerythritol, tripentaerythritol, trimethylolethane, trimethylolpropane, mannitol and sorbitol. Some embodiments of the present invention may utilize combinations of 2 or more of the above. As a non limiting example, some embodiments may utilized combinations of two or more of glycerol, pentaerythritol, and trimethylolpropane.

Some embodiments of the present invention will utilize a polyol combination of pentaerythritol and at least 1, 2, 3, 4, 5 or more other polyols, a non-limiting example of which includes pentaerythritol and at least one of glycerol or trimethylolpropane (TMP). The combination may be added as a mixture of the pentraeythritol and the other polyol(s), or may the combination may be added as a sequential additional of the pentraeythritol followed by the other polyol(s), or the one or more of the polyol(s) followed by the pentraeythritol. Thus, some embodiments of the present invention may utilize a sequential addition of pentaerythritol followed by at least 1, 2, 3, 4, 5 or more other polyols, non-limiting example of which include pentaerythritol followed by glycerol, pentaerythritol followed by trimethylolpropane, pentraeythriol followed by glycerol then trimethylolpropane, pentraeythriol followed by trimethylolpropane then glycerol, or pentraeythriol followed by a mixture of glycerol and trimethylolpropane. Some embodiments of the present invention may utilize the addition of a mixture of pentaerythritol and glycerol, a mixture of pentraeythriol and trimethylolpropane, or a mixture of pentraeythriol, glycerol and trimethylolpropane.

Some embodiments of the present invention will utilize a combination of a glycerol and/or trimethylolpropane and at least 1, 2, 3, 4, or 5 other polyols. The combination may be added as a mixture of the glycerol and/or trimethylolpropane and the other polyol(s), or may the combination may be added as a sequential additional of the glycerol and/or trimethylolpropane followed by the other polyol(s), or the one or more of the polyol(s) followed by the glycerol. Thus, some embodiments of the present invention may utilize a sequential addition of glycerol and/or trimethylolpropane at least 1, 2, 3, 4, 5 or more other polyols followed by the glycerol, a non-limiting example of which includes glycerol followed by pentaerythritol, trimethylolpropane followed by pentaerythritol, or glycerol and trimethylolpropane (together or in either order) followed by pentaerythritol.

The polyol combinations described above may comprise weight percent pentaerythritol (based on the total weight of the polyols in the combination) at or below 0, 0.001, 0.01, 0.1, 1, 2, 3, 4, 5, 6, 7, 8, 9, 10, 15, 17.5, 20, or in any range from/to or between any two of the foregoing numbers.

The amount of the alcohol employed in the esterification process may be varied widely. Generally, however, at least about an equivalent amount of polyhydric alcohol, based on the amount of rosin, is employed, with the upper limit generally being about 50% excess over the equivalent.

In some embodiments of the present invention, the rosin may be subjected to an adduction step prior to contracting the alcohol. In some embodiments, the adduction agents may be selected to react most readily with the PAN isomers of the rosin through a Diels-Alder reaction or an Ene reaction. Non-limiting examples of suitable adduction agents include, but is not limited to, unsaturated acids or their equivalents like anhydrides.

In some embodiments of the present invention, a sufficient amount of PAN isomers may be present in the rosin after the disproportionation step to allow reaction with the adduction agent. In some embodiments a sufficiently low PAN isomers may be required as too many unreacted PAN acid isomers (either free acids or esterified acids) present in the final rosin ester may in some circumstances lead to poor oxidation stability upon storage which may result in poor color stability and poor odor. Non-limiting examples of suitable PAN numbers for rosin to be subjected to adduction (i.e., pre-adduction PAN number) include 0.1, 1, 2, 5, 10, 15, 20, 25, 35, 35, 40, or 45, or in any range from/to or between any two of the foregoing numbers. Non-limiting examples of suitable ranges includes but is not limited to, 20-25, 15-30, and 10-40.

Non-limiting examples of suitable adducting agents include but are not limited to fumaric acid, maleic anhydride, acrylic acid, and other unsaturated acids or their equivalents like anhydrides.

In some embodiments, the adduction step is may be utilized to further reduce the level of the PAN rosin isomers left after the disproportionation. In some embodiments, the adduction step may increases the molecular weight and the softening point of the rosin ester. In some embodiments, this may allow placement of pentaerythritol (PE) with other polyols like glycerol or TMP that may provide lower odor esters but may also have lower softening points than PE esters. As a non-limiting example, a fumaric acid adducted glycerol ester may have a similar softening point to a PE ester and may be used for similar applications but may possess greater oxidation resistance and a lower odor. In some embodiments, a partial disproportionation step may further increase the oxidation resistance and may lower the odor of the final rosin ester. For some embodiments, as shown by Examples below, the higher levels of fumaric acid provide lower odor rosin esters as judged by our odor panel when compared to a standard commercial PE rosin ester.

In some embodiments, the adduction agent may be utilized at or above 0.1, 1, 1.5, 2, 2.5, 3, 3.5, 4, 4.5, 5, 5.5, 6, 10, 20, 30 weight percent of the formulation, or in any range from/to or between any two of the foregoing numbers. As a non-limiting example, the fumaric acid levels of about 2-2.8% of the formulation raises the weight average molecular weight Mw of the resultant rosin ester to about 1200-1600 Daltons as compared to about 900-1000 Daltons for a PE rosin ester. For some embodiments, 2.4-2.8% fumaric acid may be desired.

Some embodiments of the rosin ester may exhibit reduced odor intensity when compared to PE rosin esters. As non-limiting examples, the odor intensity of certain embodiments of rosin esters (which utilize less then 100% PE), will have relative intensities (relative to rosin esters utilizing 100% PE) that are 80%, 75%, 65%, 60%, 55%, 50%, 45%, 40%, 35%, 30% of rosin esters utilizing 100% PE.

Some embodiments of the rosin esters of the present invention may find use as tackifier resins in hot melt adhesives and as binding resins in low color, overprint varnishes used in the printing, for example, high gloss magazines, advertising and corporate annual reports

### EXAMPLES

The following Examples, with results shown in Tables 1-6 below, illustrate the advantages of the present invention by means of the results of the various types of tests and evaluations conducted on the rosin ester of this invention.

The Examples were conducted generally as follows:
600 g. of light colored (3.2 neat Gardner color) tall oil rosin (Sylvaros™ R Type S) was melted under nitrogen at 180° C. in a 2-liter 3-neck flask.
To this was added 3.53 g. of Rosinox™ disproportionation agent, with the resultant mixture heated to 275° C. for 2 hours with a slow nitrogen flow through the reactor along with the addition of 3.9 ml/hr of distilled water to the flask using a syringe pump.
Next the flask was cooled to 180° C. and 19.77 g. (2.8% of total charge) of fumaric acid was added, with the resultant mixture heated to 220° C. for 1 hr followed by cooling to 180° C.
At this point the pentaerythritol was added followed by the glycerol and the temperature was raised to 250° C.
Upon reaching 250° C., 1.06 g of tris-(nonylphenyl) phosphite (TNPP) was added.
After 1 hour the temperature was dropped to 180° C. overnight (13 hrs).
The next morning it was heated to 250° C. for 2 hours.
A reactor sample had an 85.2° C. softening point, a 24.5 acid number, and a 2 neat Gardner color.
The reaction was heated to 275° C. and sparged with nitrogen for 4 hours.
The reaction was next cooled and 0.14 g. of 50% aq. KOH, 0.99 g. of Irganox™ 1010, and 0.35 g of Irganox™ 565 were added. The 200° C. resin was poured into pans to cool.
Final analysis: softening point 98.3° C., acid number 4.9, and a 2+ neat Gardner color.

Odor panel evaluations of five non-limiting embodiments of the present rosin ester at 50° C. were compared to a commercial rosin ester, Sylvalite® Rosin Ester with low numbers representing low odor intensity.

### Example 1

Significant odor reduction was seen in some inventive embodiments as illustrated in Table 1.

Specifically, samples D and E had the highest fumaric acid content, (Sylvalite® Rosin Ester has none). Without being limited by theory, applicants postulate that this surprisingly may be one of the factors related to the odor reduction. One non-limiting hypothesis is that the fumaric acid preferentially reacts with the most reactive rosin isomers, which might also be related to odor generation.

TABLE 1
Odor Intensity vs. Fumaric
Adduction Level (Odor Intensity Relative to Sylvalite ® Rosin
Ester)

| | | Fumaric Acid |
|---|---|---|
| Resin | Relative Intensity | Adduction |
| E | 0.45 | 2.8% |
| D | 0.55 | 2.4% |
| A | 0.55 | 2.2% |
| C | 0.56 | 2.2% |
| B | 0.59 | 2.0% |
| Sylvalite ® Rosin | 1.00 | 0% |
| Ester | | |

### Example 2

Table 2 shows odor panel data on test resin formulations made with a constant 2% fumaric acid (FA) adduction and consistent process conditions but with varying levels of pentaerythritol replacing some of the glycerol. These results are consistent with earlier speculations that pentaerythritol impurities or decomposition products produced during the high temperature esterification process contribute to the unpleasant odors in the final ester. This would therefore suggest that for some embodiments, if PE is used, that it be kept to a low level in order to minimize odor of resulting rosin ester.

TABLE 2
Odor Intensity vs. Pentaerythritol Level

| | | PE as | |
|---|---|---|---|
| | | % of | |
| Resin | Odor Intensity Relative | Total | |
| Formulation | to Sylvalite ® Rosin Ester | Polyol | % FA |
| B | 0.59 | 2 | 2.0 |
| 24 | 0.69 | 2 | 2.0 |
| 19 | 0.70 | 10 | 2.0 |
| 18 | 0.75 | 17.5 | 2.0 |
| 16 | 0.81 | 17.5 | 2.0 |
| 17 | 1.11 | 25.0 | 2.0 |

### Example 3

Table 3 shows the high oxidation resistance of certain embodiments of the present inventive with the disproportionation step included in the process. At 150° C. in air for 24 hours, the inventive tackifier resins, especially favored formulations C and D, showed much less color darkening than the control. While not necessarily true for all embodiments, at least for the embodiment of this Example, disproportionation provides a resin ester having properties more desirable in some circumstances. Thus, depending upon the desired end use, in certain circumstances, it may be desired to require a disproportionation step. Similarly in an EVA based adhesive formulation, certain embodiment of the present inventive tackifier resins showed better color than in the control.

TABLE 3
Oxidation Stability and Color Improvements from this Invention

| | | | | | EVA ADHESIVE COLOR | | |
|---|---|---|---|---|---|---|---|
| | | | NEAT RE | | 24 h | | |
| | | Oxid. | COLOR | | Color | EVA | |
| | | DSC | | 24 | Gain | Adhesive | EVA/72 h |
| | | Stability | Initial | Hours | 150 C. | Initial | At |
| Sample | | (min) | Color | 150 C. | Gain | color | 130 C. |
| Sylvalite ® | (Control RE) | 13.2 | 2.5 | 4.1 | 1.6 | 2.8 | 3.1 |
| Rosin | | | | | | | |
| Ester | | | | | | | |
| #3 | New process | 7.9 | 2.7 | 7.0 | 4.3 | | |
| | Without | | | | | | |
| | disproportionation | | | | | | |
| #13 | New process | 37.6 | 2.2 | 3.5 | 1.3 | 1.2 | 1.5 |
| #20 | New process | 65.2 | 2.5 | 3.7 | 1.2 | 1.5 | 2.9 |
| #21 | New process | 45.7 | 2.9 | 3.5 | 0.6 | 2.0 | 2.7 |
| A | New process | 55.7 | | | | 1.2 | 2.3 |
| C | New process | 53.4 | 2.2 | 2.4 | 0.2 | | |
| D | New process | 49.1 | 2.1 | 2.3 | 0.2 | 1.2 | 2.1 |

DSC = differential Scanning Calorimetry. In oxidative DSC the sample is heated under 550 psi oxygen pressure at 128° C. until the sample oxidizes as shown by its heat emission.
EVA = ethylene vinyl acetate copolymer.

### Example 4

Table 4 shows an odor comparison made between a commercial SIS/hydrogenated hydrocarbon resin tackified adhesive and SIS adhesives made with rosin ester tackifiers. For these embodiments, adhesives made with a top grade of commercially available (Arizona Chemical) pentaerythritol rosin ester and adhesives made certain embodiments of the present inventive ester without the disproportionation step showed similar or stronger odors than the commercial adhesive. However, adhesives made with sample resins from certain embodiments of the present invention were judged by an odor panel to have a significantly lower odor than the commercial SIS adhesive.

TABLE 4
Odor comparison of SIS Adhesives using New Rosin Ester Tackifiers to a
Commercial SIS/Hydrocarbon Resin Adhesive

| | | Odor relative |
|---|---|---|
| SIS Adhesive | | to Commercial |
| Formulation | | SIS/ |
| Made | | Hydrocarbon |
| Using | Comments | Adhesive |
| Commercial PE | Control | 1.00 |
| Ester | | |
| #1 | New Resin without | 1.00 |
| | Disproportionation | |
| #3 | New Resin without | 1.25 |
| | Disproportionation | |
| #9 | New Resin | 0.75 |
| #10 | New resin | 0.87 |

SIS = Styrene-isoprene-styrene block copolymer
Low numbers indicate a lower odor intensity

### Example 5

Rosin ester C from certain embodiments of the present invention was also evaluated in a standard pressure-sensitive adhesive formulation based on Styrene-Isoprene-Styrene (SIS) for label applications. The results were compared to those obtained for a standard commercial rosin ester, Sylvalite® Rosin Ester. The results are shown in Table 5. Although the rosin ester of the invention exhibited a lower loop tack, overall it performed comparably or better than the commercial rosin ester; and therefore would be expected to be an acceptable tackifier for such adhesives.

TABLE 5
Adhesive performance of SIS-based HMPSA Label formulations using
Rosin Ester C and Commercial Sylvalite ® Rosin Ester

| | | | | Loop tack | Peel |
|---|---|---|---|---|---|
| | G′/G″ | | | (stainless | (stainless |
| | Temp. | Tg | SAFT | Steel) | Steel) |
| Rosin Ester C | 81° C. | 11° C. | 139° F. | 7.5 | 7.2 |
| Sylvalite ® | 69° C. | 7° C. | 133° F. | 9.2 | 7.1 |
| Rosin Ester | | | | | |

### Example 6

Rosin ester C from the present invention was also evaluated in a standard hot melt packaging adhesive formulation based on EVA. The results of the thermal stability (Color and viscosity stability) were compared to those obtained for a standard commercial rosin ester, Sylvalite® Rosin Ester. The results are shown in Table 6. The adhesive made with the rosin ester of the invention exhibited comparable stability to the commercial product; and therefore the rosin ester of this invention would be expected to be an acceptable tackifier for such adhesives.

TABLE 6
Adhesive Stability of EVA-based Hot Melt Packaging Adhesive
formulation Using Rosin Ester C and Commercial Sylvalite ®
Rosin Ester

| | | Color | | | % Change |
|---|---|---|---|---|---|
| | Initial | 96 h/ | Initial | Viscosity | Viscosity |
| | Color | 350° F. | Viscosity | 96 h/350° F. | 96 h/350° F. |
| Rosin Ester C | 1.6 | 7.2 | 1010 | 1028 | 1.8 |
| Sylvalite ® | 1.8 | 6.7 | 993 | 1045 | 5.2 |
| Rosin Ester | | | | | |

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below.

1. A method of producing a rosin ester, the method comprising:
(A) Contacting a rosin having PAN isomers with disproportionation agent to provide a rosin having a PAN number less than 45 providing a disproportionated rosin;
(B) Contacting the disproportionated rosin with an adduction agent to further reduce the PAN number to provide an adducted rosin;
(C) Contacting the adducted rosin with a polyhydric polyol to form a rosin ester.

2. The method of claim 1, wherein the disproportationation agent comprises at least one selected from among phenol sulfides, metals, iodine, iodides, and sulfides, and the adduction agent is selected to react with the PAN isomers of the rosin through a Diels-Alder reaction or an Ene reaction.

3. The method of claim 1 wherein the disproportationation agent comprises at least one selected from 2,2′-thiobis phenols, 3,3′-thiobisphenols, 4,4′-thiobis(resorcinol) and t,t′-thiobis(pyrogallol), 4,4′-thiobis(6-t-butyl-m-cresol) and 4/4′-thiobis(6-t-butyl-o-cresol) thiobisnaphthols, 2,2′-thio-bis phenols, 3,3′-thio-bis phenols, palladium, nickel, platinum, iodine, iron iodide, iron sulfide.

4. The method of claim 1, wherein the adduction agent comprises at least one selected from fumaric acid, maleic anhydride, acrylic acid, unsaturated acids and anhydrides.

5. The method of claim 1, wherein the polyhydric polyol comprises less than 20 weight percent pentaerythritol.

6. The method of claim 5, wherein the polyhydric polyol comprises at least one selected from the group consisting of ethylene glycol, propylene glycol, diethylene glycol, triethylene glycol, tetraethylene glycol, trimethylene glycol, glycerol, pentaerythritol, dipentaerythritol, tripentaerythritol, trimethylolethane, trimethylolpropane, mannitol and sorbitol.

7. The method of claim 5, wherein the polyhydric alcohol comprises at least one selected from the group consisting of glycerol and trimethylolpropane.

8. The method of claim 1, wherein the rosin ester has an odor intensity of less than 80% relative to comparison rosin ester made from 100% pentaerythritol.

9. A method of producing a rosin ester, the method comprising:
(A) Contacting rosin having a PAN number less than 45 with an adduction agent to further reduce the PAN number to provide an adducted rosin;
(B) Contacting the adducted rosin with a polyhydric polyol to form a rosin ester.

10. The method of claim 9, wherein the adduction agent is selected to react with the PAN isomers of the rosin through a Diels-Alder reaction or an Ene reaction.

11. The method of claim 9, wherein the adduction agent comprises at least one selected from fumaric acid, maleic anhydride, acrylic acid, unsaturated acids and anhydrides.

12. The method of claim 9, wherein the polyhydric polyol comprises less than 20 weight percent pentaerythritol.

13. The method of claim 12, wherein the polyhydric polyol comprises at least one selected from the group consisting of ethylene glycol, propylene glycol, diethylene glycol, triethylene glycol, tetraethylene glycol, trimethylene glycol, glycerol, pentaerythritol, dipentaerythritol, tripentaerythritol, trimethylolethane, trimethylolpropane, mannitol and sorbitol.

14. The method of claim 12, wherein the polyhydric alcohol comprises at least one selected from the group consisting of glycerol and trimethylolpropane.

15. The method of claim 9, wherein the rosin ester has an odor intensity of less than 80% relative to comparison rosin ester made from 100% pentaerythritol.

16. A rosin ester composition having an odor intensity of less than 80% relative to comparison rosin ester made from 100% pentaerythritol.

17. The composition of claim 16 having an odor intensity of less than 60% relative to comparison rosin ester made from 100% pentaerythritol.

18. The composition of claim 16 having an odor intensity of less than 55% relative to comparison rosin ester made from 100% pentaerythritol.

19. The composition of claim 16 having an odor intensity of less than 50% relative to comparison rosin ester made from 100% pentaerythritol.

20. An adhesive comprising a rosin ester composition having an odor intensity of less than 80% relative to comparison rosin ester made from 100% pentaerythritol.

21. The adhesive of claim 20 wherein the composition comprises an odor intensity of less than 60% relative to comparison rosin ester made from 100% pentaerythritol.

22. The adhesive of claim 20 wherein the composition comprises an odor intensity of less than 55% relative to comparison rosin ester made from 100% pentaerythritol.

23. The adhesive of claim 20 wherein the composition comprises an odor intensity of less than 50% relative to comparison rosin ester made from 100% pentaerythritol.

24. A non-woven product comprising an adhesive comprising a rosin ester composition having an odor intensity of less than 80% relative to comparison rosin ester made from 100% pentaerythritol.

25. The product of claim 24 wherein the odor intensity is less than 60% relative to comparison rosin ester made from 100% pentaerythritol.

27. The product of claim 24 wherein the odor intensity is less than 55% relative to comparison rosin ester made from 100% pentaerythritol.

28. The product of claim 24 wherein the odor intensity is less than 50% relative to comparison rosin ester made from 100% pentaerythritol.
